(19) United States
(12) Patent Application Publication
(10) Pub. No.: US 2015/0364069 A1
(43) Pub. Date: Dec. 17, 2015

(54) PIXEL STRUCTURE AND LIQUID CRYSTAL DISPLAY DEVICE

(71) Applicant: Shenzhen China Star Optoelectronics Technology Co. ,Ltd., Guangdong (CN)

(72) Inventors: Cheng-Hung CHEN, Guangdong (CN); Jiali Jiang, Guangdong (CN)

(73) Assignee: Shenzhen China Star Optoelectronics Technology Co. , Ltd., Guangdong (CN)

(21) Appl. No.: 14/377,178

(22) PCT Filed: May 16, 2014
(86) PCT No.: PCT/CN2014/077630

§ 371 Date: Aug. 7, 2014

(30) Foreign Application Priority Data
Apr. 10, 2014 (CN) 201410142658.6

(51) Int. Cl. G09G 3/20; G09G 3/34; G09G 3/36

(52) U.S. Cl. CPC G09G 3/2003; G09G 3/3666; G09G 3/3413; G09G 2300/0452

(57) ABSTRACT

The present invention proposes a pixel structure having a data line, a first scan line, pixel zones, a second scan line, and a common line. Each pixel zone includes a first subpixel zone and a second subpixel zone. The first subpixel zone includes a first switch and a first pixel capacitor. The second subpixel zone includes a second switch, a second pixel capacitor, and a color shift adjusting switch. An adjustment of color shift is controlled by adjusting the color shift adjusting switch and the second scan line.

### BACKGROUND OF THE INVENTION

1. Field of the Invention

The present invention relates to a liquid crystal technology field, more particularly, to a pixel structure and a liquid crystal display device.

2. Description of the Prior Art

As liquid crystal display technology develops, the number of liquid crystal display device users is increasing. However, when a liquid crystal display device is viewed under a wide viewing angle, color shift from the original occurs due to different liquid crystal alignments in different angels, resulting in color distortion.

To improve color distortion of the liquid crystal display device under wide-angel, as part of pixel structure designing, a pixel (red, green or blue) is usually divided into two halves. Color distortion under wide-angel is improved through controlling driving voltage of these two pixel halves, which is usually called low-color-shift design. FIG. 1 indicates a structure diagram of a pixel structure of a conventional liquid crystal display device.

The pixel structure comprises a scan line Gₙ, a scan line Gₙ₊₁ and a scan line Gₙ₊₂; a data line Dₙ; a common line COMₙ and a common line COMₙ₊₁; a thin film transistor TFT_{A}; a thin film transistor TFT_{B} and a thin film transistor TFT_{C}; a pixel capacitor C_{lcA} and a pixel capacitor C_{lcB}; a storage capacitor C_{stA}; a storage capacitor C_{stB}; and a adjusting capacitor Cₛₕₐᵣₑ.

When the liquid crystal display device is used, high voltage level signal is input to the scan line G_{n,} the thin film transistors TFT_{A} and TFT_{B} are conducted, the data line Dₙ charges the pixel capacitors C_{lcA} and C_{lcB}, and the pixel capacitors C_{lcA} and C_{lcB} have the same voltage.

And then high voltage level signal is input to the scan line Gₙ₊₁, the thin film transistor TFT_{C} is conducted, and the thin film transistor TFT_{A} and TFT_{B} disconnect; the pixel capacitors C_{lcB} and C_{lcA} form a fixed differential pressure by the adjusting capacitor C_{share,} electric potential of the pixel capacitor C_{lcB} is lowered, and a differential pressure exists between the pixel capacitors C_{lcA} and C_{lcB}, hence color distortion is weakened or eliminated.

However, the mentioned low-color-shift design mainly adjusts color shift by adjusting the capacity of the capacitor Cₛₕₐᵣₑ. If the adjusting capacitor Cₛₕₐᵣₑ is fixed, adjust of color shift is fixed; when users ask for new color shift effects, the adjusting capacitor Cₛₕₐᵣₑ has to be redesigned or replaced, which leads to higher cost.

Therefore, a pixel structure and liquid crystal display device is needed to solve the problems of contemporary art.

### SUMMARY OF THE INVENTION

It is therefore a primary object of the present invention to provide a pixel structure and liquid crystal display device with adjustable color shift effects, to prevent rising cost of the liquid crystal display device due to the pixel structure and liquid crystal display device with un-adjustable color shift effects.

According to the present invention, a pixel structure comprises a data line for transmitting data signals, a first scan line for transmitting scan signals, a plurality of pixel zones formed by interlocking of the data line and the first scan line, a second scan line for transmitting color shift adjusting signals, and a common line for transmitting common signals. Each pixel zone comprises a first subpixel zone and a second subpixel zone. The first subpixel zone comprises a first switch, a first pixel capacitor and a first storage capacitor. An input end of the first switch is connected to the data line. An output end of the first switch is connected to the first pixel capacitor. A control end of the first switch is connected to the scan line. One end of the first storage capacitor is connected to the output end of the first switch, and the other end of the first storage capacitor is connected to the common line. The second subpixel zone comprises a second switch, a second pixel capacitor, a second storage capacitor and a color shift adjusting switch. An input end of the second switch is connected to the data line. An output end of the second switch is connected to the second pixel capacitor. A control end of the second switch is connected to the scan line. An input end of the color shift adjusting switch is connected to the common line. A control end of the color shift adjusting switch is connected to the second scan line. One end of the second storage capacitor is connected to the output end of the second switch, and the other end of the second storage capacitor is connected to the common line.

In one aspect of the present invention, color shift of the first subpixel zone and the second subpixel zone is adjusted according to color shift adjusting signals on the second scan line.

In another aspect of the present invention, after the first switch and the second switch disconnect in a first set-up interval, the color shift adjusting switch is conducted by the color shift adjusting signal in a second set-up interval, so that color shift of the first subpixel zone and the second subpixel zone is adjusted.

In still another aspect of the present invention, color shift of the first subpixel zone and the second subpixel zone is adjusted by controlling the first set-up interval, the second set-up interval and a color shift sustaining interval. The first set-up interval is a time of period when no color shift exist between the first subpixel zone and the second subpixel zone. The second set-up interval is a time of period when magnitude of color shift between the first subpixel zone and the second subpixel zone is controlled. The color shift sustaining interval is a time of period when the first subpixel zone and the second subpixel zone sustain after the color shift is adjusted.

According to the present invention, a pixel structure comprises a data line for transmitting data signals, a first scan line for transmitting scan signals, a plurality of pixel zones formed by interlocking of the data line and the first scan line, a second scan line for transmitting color shift adjusting signals, and a common line for transmitting common signals. Each pixel zone comprises a first subpixel zone and a second subpixel zone. The first subpixel zone comprises a first switch and a first pixel capacitor. An input end of the first switch is connected to the data line. An output end of the first switch is connected to the first pixel capacitor. A control end of the first switch is connected to the scan line. The second subpixel zone comprises a second switch, a second pixel capacitor, and a color shift adjusting switch. An input end of the second switch is connected to the data line. An output end of the second switch is connected to the second pixel capacitor. A control end of the second switch is connected to the scan line. An input end of the color shift adjusting switch is connected to the common line. A control end of the color shift adjusting switch is connected to the second scan line.

In one aspect of the present invention, color shift of the first subpixel zone and the second subpixel zone is adjusted according to color shift adjusting signals on the second scan line.

In another aspect of the present invention, after the first switch and the second switch disconnect in a first set-up interval, the color shift adjusting switch is conducted by the color shift adjusting signal in a second set-up interval, so that color shift of the first subpixel zone and the second subpixel zone is adjusted.

In still another aspect of the present invention, color shift of the first subpixel zone and the second subpixel zone is adjusted by controlling the first set-up interval, the second set-up interval and a color shift sustaining interval. The first set-up interval is a time of period when no color shift exist between the first subpixel zone and the second subpixel zone. The second set-up interval is a time of period when magnitude of color shift between the first subpixel zone and the second subpixel zone is controlled. The color shift sustaining interval is a time of period when the first subpixel zone and the second subpixel zone sustain after the color shift is adjusted.

In still another aspect of the present invention, a first subpixel zone further comprises a first storage capacitor, one end of the first storage capacitor is connected to the output end of the first switch, and the other end of the first storage capacitor is connected to the common line.

In yet another aspect of the present invention, a second subpixel zone further comprises a second storage capacitor, one end of the second storage capacitor is connected to the output end of the second switch, and the other end of the second storage capacitor is connected to the common line.

According to the present invention, a liquid crystal display (LCD) device comprises a backlight module and an LCD panel comprising a pixel structure. The pixel structure comprises a data line for transmitting data signals, a first scan line for transmitting scan signals, a plurality of pixel zones formed by interlocking of the data line and the first scan line, a second scan line for transmitting color shift adjusting signals, and a common line for transmitting common signals. Each pixel zone comprises a first subpixel zone and a second subpixel zone. The first subpixel zone comprises a first switch and a first pixel capacitor. An input end of the first switch is connected to the data line. An output end of the first switch is connected to the first pixel capacitor. A control end of the first switch is connected to the scan line. The second subpixel zone comprises a second switch, a second pixel capacitor, and a color shift adjusting switch. An input end of the second switch is connected to the data line. An output end of the second switch is connected to the second pixel capacitor. A control end of the second switch is connected to the scan line. An input end of the color shift adjusting switch is connected to the common line. A control end of the color shift adjusting switch is connected to the second scan line.

In one aspect of the present invention, color shift of the first subpixel zone and the second subpixel zone is adjusted according to color shift adjusting signals on the second scan line.

In another aspect of the present invention, after the first switch and the second switch disconnect in a first set-up interval, the color shift adjusting switch is conducted by the color shift adjusting signal in a second set-up interval, so that color shift of the first subpixel zone and the second subpixel zone is adjusted.

In still another aspect of the present invention, color shift of the first subpixel zone and the second subpixel zone is adjusted by controlling the first set-up interval, the second set-up interval and a color shift sustaining interval. The first set-up interval is a time of period when no color shift exist between the first subpixel zone and the second subpixel zone. The second set-up interval is a time of period when magnitude of color shift between the first subpixel zone and the second subpixel zone is controlled. The color shift sustaining interval is a time of period when the first subpixel zone and the second subpixel zone sustain after the color shift is adjusted.

In still another aspect of the present invention, a first subpixel zone further comprises a first storage capacitor, one end of the first storage capacitor is connected to the output end of the first switch, and the other end of the first storage capacitor is connected to the common line.

In yet another aspect of the present invention, a second subpixel zone further comprises a second storage capacitor, one end of the second storage capacitor is connected to the output end of the second switch, and the other end of the second storage capacitor is connected to the common line.

Compared to conventional pixel structure and liquid crystal display device, the pixel structure and liquid crystal display device of the present invention adjusts color shift effect by a color shift switch and a second scan line, thus solves rising cost of the liquid crystal display device due to the pixel structure and liquid crystal display device with un-adjustable color shift effects.

These and other features, aspects and advantages of the present disclosure will become understood with reference to the following description, appended claims and accompanying figures.

### BRIEF DESCRIPTION OF THE DRAWINGS

FIG. 1 indicates a structure diagram of a pixel structure of a conventional liquid crystal display device.

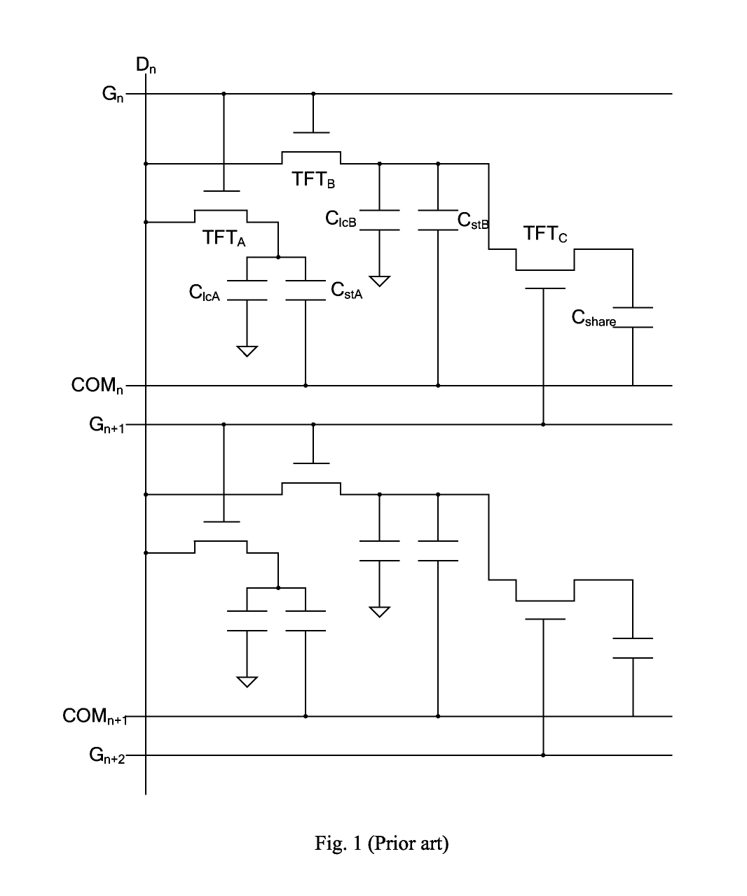

FIG. 2 is a structure diagram of a pixel structure of the liquid crystal display device according to a preferred embodiment of the present invention.

FIG. 3 is a driving signal diagram of the liquid crystal display device according to another preferred embodiment of the present invention.

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It is noted that the same components are labeled by the same number.

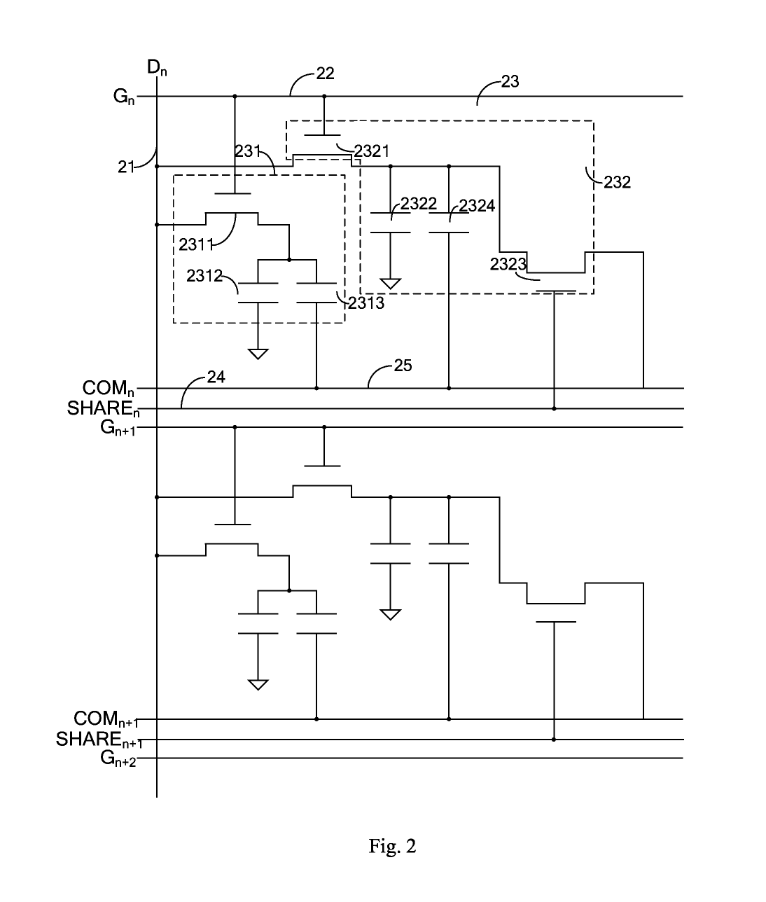

Please refer to FIG. 2, a structure diagram of a pixel structure of the liquid crystal display device according to a preferred embodiment of the present invention. The pixel structure of the liquid crystal display device of the preferred embodiment in the present invention comprises a data line 21, a first scan line 22, a plurality of pixel zones 23, a second scan line 24 and a common line 25. The data line 21 transmits data signals, the first scan line 22 transmits scan signals, the second scan line 24 transmits color-shift adjusting signals, the common line 25 transmits common signals. The data line 21 comprises a data line Dn; the first scan line 22 comprises a first scan line G1, a first scan line G2, a first scan line Gn, a first scan line Gn+1, and a first scan line Gn+2; the second scan line 24 comprises a second scan line SHARE 1, a second scan line SHARE 2, a second scan line SHAREn and a second scan line SHAREn+1; the common line comprises a common line COMn and a common line COMn+1.

The pixel zone 23 is formed by interlocking of the data line 21 and the first scan line 22, comprising a first subpixel zone 231 and a second subpixel zone 232. The first subpixel zone 231 comprises a first switch 2311 and a first pixel capacitor 2312; the input end of the first switch 2311 is connected to the data line 21, the output end of the first switch 2311 is connected to the first pixel capacitor 2312, and the control end of the first switch 2311 is connected to the first scan line 22. The second subpixel zone 232 comprises a second switch 2321, a second pixel capacitor 2322 and a color shift adjusting switch 2323. The input end of the second switch 2321 is connected to the data line 21, the output end of the second switch 2321 is connected to the second pixel capacitor 2322, and the control end of the second switch 2321 is connected to the first scan line 22. The input end of the color shift adjusting switch 2323 is connected to the output end of the second switch 2321, the output end of the color shift adjusting switch 2323 is connected to the common line 25, and the control end of the color shift adjusting switch 2323 is connected to the second scan line 24.

The first subpixel zone 231 also comprises a first storage capacitor 2313, one end of which is connected to the output end of the first switch 2311, and the other end is connected to the common line 25. The second subpixel zone 232 also comprises a second storage capacitor 2324, one end of which is connected to the output end of the second switch 2321, and the other end is connected to the common line 25.

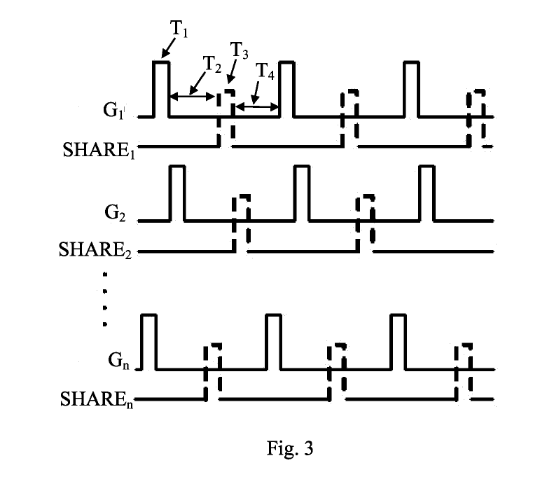

When using the liquid crystal display device of the preferred embodiment, please refer to FIG. 3, a driving signal diagram of the liquid crystal display device according to another preferred embodiment of the present invention. The first scan line 22 inputs high voltage level scan signal to the control end of the first switch 2311; the first switch 2311 conducts as a result, and the data signal on the data line 21 is input to the first pixel capacitor 2312 through the first switch 2311. In the meantime, the first scan line 22 inputs high voltage level scan signal to the control end of the second switch 2321; the second switch 2321 conducts as a result, and the data signal on the data line 21 is input into the second pixel capacitor 2322 through the second switch 2321.

After an interval T1, the voltage of both ends of the first capacitor 2312 and the voltage of both ends of the second capacitor 2322 are sufficient to drive the liquid crystal molecules to deviate. The first scan line 22 inputs low voltage level scan signal to the control end of the first switch 2311; the first switch 2311 disconnects as a result, and the first pixel capacitor 2312 sustains voltage of both ends. In the meantime, the first scan line 22 inputs low voltage level scan signal to the control end of the second switch 2321; the second switch 2321 disconnects as a result, and the second pixel capacitor 2322 sustains voltage of both ends as well. In this period, the voltage of both ends of the first capacitor 2312 and the voltage of both ends of the second capacitor 2322 are equal.

After a first set-up interval T2, the second scan line 24 inputs high voltage level color shift adjusting signals to the control end of the color shift adjusting switch 2323; the color shift adjusting switch 2323 conducts, and the electricity on the second pixel capacitor is released to the common line 25 through the color shift adjusting switch 2323; voltage on both ends of the second pixel capacitor 2322 decreases, resulting in a lower voltage of the both ends of the second pixel capacitor 2322 than that of the both ends of the first pixel capacitor 2312.

Finally, after a second set up interval T3, the second scan line 24 inputs high voltage level color shift adjusting signals to the control end of the color shift adjusting switch 2323; the color shift adjusting switch 2323 conducts, and the electricity on the second pixel capacitor stops being released to the common line 25 through the color shift adjusting switch 2323; voltage on both ends of the second pixel capacitor 2322 is stable, resulting in a fixed differential pressure between the voltage of the both ends of the second pixel capacitor 2322 and the voltage of the both ends of the first pixel capacitor 2312. Hence, deviation angels of liquid crystal of the first subpixel zone 231 corresponding to the first pixel capacitor 2313 and the second subpixel zone 232 corresponding to the second pixel capacitor 2322 are different, resulting in a color shift between the first subpixel zone 231 and the second subpixel zone 232, which effectively eliminates color distortion of the liquid crystal display device.

The first set up interval T2 controls the time of period when the first subpixel zone 231 and the second subpixel zone 232 have no color shift; the second set up interval T3 controls the magnitude of color shift between the first subpixel zone 231 and the second subpixel zone 232; and a T4 stands for the time of period when color shift exits between the first subpixel zone 231 and the second subpixel zone 232. By adjusting the first set up interval T2, the second set up interval T3 and the color shift sustaining time T4, users can control the color shift of the first subpixel zone 231 and the second subpixel zone 232 during a unit time when the liquid crystal display device is displaying as a whole. If T2 is larger, the color shift of the first subpixel zone 231 and the second subpixel zone 232 during a unit time becomes smaller; if T3 is larger, the color shift of the first subpixel zone 231 and the second subpixel zone 232 during a unit time becomes larger; if T4 is larger, the color shift of the first subpixel zone 231 and the second subpixel zone 232 during a unit time becomes larger.

Preferably, by adjusting the second set up interval T3, the pixel structure of the liquid crystal display device of the embodiment controls differential pressure of the voltage of both ends of the second pixel capacitor 2322 and the voltage of both ends of the first pixel capacitor 2312, thus adjusts color shift effect. If the color shift effect between the first subpixel zone 231 and the second subpixel zone 232 wants weakening, the second set up interval T3 can be shortened; if the color shift effect between the first subpixel zone 231 and the second subpixel zone 232 wants strengthening, the second set up interval T3 can be prolonged. Therefore, the color shift of the first subpixel zone 231 and the second subpixel zone 232 can be adjusted by using color shift adjusting signal on the second scan line 24, thus color shift effect of the liquid crystal display device is adjustable, and manufacturing cost of the liquid crystal display device is decreased.

In all pixels of the pixel structure, if the first set up interval T2, the second set up interval T3 and the color shift sustaining period T4 can be adjusted in real time, the color shift effect of the liquid crystal display device is adjustable as a whole.

The first subpixel zone 231 of the pixel structure of the liquid crystal display device also comprises a first storage capacitor 2313, one end of which is connected to the output end (i.e. one end of the first pixel capacitor 2312) of the first switch 2311, the other end is connected to the common line 25. The first storage capacitor 2313 sustains the voltage of both ends of the first pixel capacitor 2312, thus ensure the stability of image displaying in the first subpixel zone 231.

The second subpixel zone 232 of the pixel structure of the liquid crystal display device of the preferred embodiment also comprises a second storage capacitor 2324, one end of which is connected to the output end (i.e. one end of the second pixel capacitor 2322) of the second switch 2321, the other end is connected to the common line 25. The second storage capacitor 2324 sustains the voltage of both ends of the second pixel capacitor 2322, thus ensure the stability of image displaying in the second subpixel zone 232.

The pixel structure and liquid crystal display device in the present invention adjusts color shift effect by the color shift switch and the second scan line, thus solves rising cost of the liquid crystal display device due to the extant pixel structure and liquid crystal display device with un-adjustable color shift effects.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A pixel structure comprising:
a data line for transmitting data signals;
a first scan line for transmitting scan signals;
a plurality of pixel zones formed by interlocking of the data line and the first scan line;
a second scan line for transmitting color shift adjusting signals; and
a common line for transmitting common signals;
wherein each pixel zone comprises:
a first subpixel zone, comprising a first switch, a first pixel capacitor and a first storage capacitor, wherein an input end of the first switch is connected to the data line, an output end of the first switch is connected to the first pixel capacitor, and a control end of the first switch is connected to the scan line; one end of the first storage capacitor is connected to the output end of the first switch, and the other end of the first storage capacitor is connected to the common line;
a second subpixel zone, comprising a second switch, a second pixel capacitor, a second storage capacitor and a color shift adjusting switch, wherein an input end of the second switch is connected to the data line, an output end of the second switch is connected to the second pixel capacitor, and a control end of the second switch is connected to the scan line; a input end of the color shift adjusting switch is connected to the common line; a control end of the color shift adjusting switch is connected to the second scan line; one end of the second storage capacitor is connected to the output end of the second switch, and the other end of the second storage capacitor is connected to the common line.

2. The pixel structure of claim 1, wherein color shift of the first subpixel zone and the second subpixel zone is adjusted according to color shift adjusting signals on the second scan line.

3. The pixel structure of claim 2, wherein after the first switch and the second switch disconnect in a first set-up interval, the color shift adjusting switch is conducted by the color shift adjusting signal in a second set-up interval, so that color shift of the first subpixel zone and the second subpixel zone is adjusted.

4. The pixel structure of claim 2, wherein color shift of the first subpixel zone and the second subpixel zone is adjusted by controlling the first set-up interval, the second set-up interval and a color shift sustaining interval; the first set-up interval is a time of period when no color shift exist between the first subpixel zone and the second subpixel zone, the second set-up interval is a time of period when magnitude of color shift between the first subpixel zone and the second subpixel zone is controlled, and the color shift sustaining interval is a time of period when the first subpixel zone and the second subpixel zone sustain after the color shift is adjusted.

5. A pixel structure comprising:
a data line for transmitting data signals;
a first scan line for transmitting scan signals;
a plurality of pixel zones formed by interlocking of the data line and the first scan line;
a second scan line for transmitting color shift adjusting signals; and
a common line for transmitting common signals;
wherein each pixel zone comprises:
a first subpixel zone, comprising a first switch and a first pixel capacitor, wherein an input end of the first switch is connected to the data line, an output end of the first switch is connected to the first pixel capacitor, and a control end of the first switch is connected to the scan line;
a second subpixel zone, comprising a second switch, a second pixel capacitor, and a color shift adjusting switch, wherein an input end of the second switch is connected to the data line, an output end of the second switch is connected to the second pixel capacitor, and a control end of the second switch is connected to the scan line; a input end of the color shift adjusting switch is connected to the common line; a control end of the color shift adjusting switch is connected to the second scan line.

6. The pixel structure of claim 5, wherein color shift of the first subpixel zone and the second subpixel zone is adjusted according to color shift adjusting signals on the second scan line.

7. The pixel structure of claim 6, wherein after the first switch and the second switch disconnect in a first set-up interval, the color shift adjusting switch is conducted by the color shift adjusting signal in a second set-up interval, so that color shift of the first subpixel zone and the second subpixel zone is adjusted.

8. The pixel structure of claim 6, wherein color shift of the first subpixel zone and the second subpixel zone is adjusted by controlling the first set-up interval, the second set-up interval and a color shift sustaining interval; the first set-up interval is a time of period when no color shift exist between the first subpixel zone and the second subpixel zone, the second set-up interval is a time of period when magnitude of color shift between the first subpixel zone and the second subpixel zone is controlled, and the color shift sustaining interval is a time of period when the first subpixel zone and the second subpixel zone sustain after the color shift is adjusted.

9. The pixel structure of claim 5, wherein a first subpixel zone further comprises a first storage capacitor, one end of the first storage capacitor is connected to the output end of the first switch, and the other end of the first storage capacitor is connected to the common line.

10. The pixel structure of claim 5, wherein a second subpixel zone further comprises a second storage capacitor, one end of the second storage capacitor is connected to the output end of the second switch, and the other end of the second storage capacitor is connected to the common line.

11. A liquid crystal display (LCD) device, comprising:
a backlight module; and
an LCD panel comprising a pixel structure, the pixel structure comprising:
a data line for transmitting data signals;
a first scan line for transmitting scan signals;
a plurality of pixel zones formed by interlocking of the data line and the first scan line;
a second scan line for transmitting color shift adjusting signals; and
a common line for transmitting common signals;
wherein each pixel zone comprises:
a first subpixel zone, comprising a first switch and a first pixel capacitor, wherein an input end of the first switch is connected to the data line, an output end of the first switch is connected to the first pixel capacitor, and a control end of the first switch is connected to the scan line;
a second subpixel zone, comprising a second switch, a second pixel capacitor, and a color shift adjusting switch, wherein an input end of the second switch is connected to the data line, an output end of the second switch is connected to the second pixel capacitor, and a control end of the second switch is connected to the scan line; a input end of the color shift adjusting switch is connected to the common line; a control end of the color shift adjusting switch is connected to the second scan line.

12. The LCD device of claim 11, wherein color shift of the first subpixel zone and the second subpixel zone is adjusted according to color shift adjusting signals on the second scan line.

13. The LCD device of claim 12, wherein after the first switch and the second switch disconnect in a first set-up interval, the color shift adjusting switch is conducted by the color shift adjusting signal in a second set-up interval, so that color shift of the first subpixel zone and the second subpixel zone is adjusted.

14. The LCD device of claim 12, wherein color shift of the first subpixel zone and the second subpixel zone is adjusted by controlling the first set-up interval, the second set-up interval and a color shift sustaining interval; the first set-up interval is a time of period when no color shift exist between the first subpixel zone and the second subpixel zone, the second set-up interval is a time of period when magnitude of color shift between the first subpixel zone and the second subpixel zone is controlled, and the color shift sustaining interval is a time of period when the first subpixel zone and the second subpixel zone sustain after the color shift is adjusted.

15. The LCD device of claim 11, wherein a first subpixel zone further comprises a first storage capacitor, one end of the first storage capacitor is connected to the output end of the first switch, and the other end of the first storage capacitor is connected to the common line.

16. The LCD device of claim 11, wherein a second subpixel zone further comprises a second storage capacitor, one end of the second storage capacitor is connected to the output end of the second switch, and the other end of the second storage capacitor is connected to the common line.
